(19) United States
(12) Patent Application Publication
(10) Pub. No.: US 2020/0341809 A1
(43) Pub. Date: Oct. 29, 2020

(54) ELECTRONIC DEVICE, CONTROL APPARATUS, INFORMATION PROCESSING APPARATUS, AND INFORMATION PROCESSING SYSTEM

(71) Applicant: SHARP KABUSHIKI KAISHA, Sakai City (JP)

(72) Inventor: KAZUO TAKADA, Sakai City (JP)

(21) Appl. No.: 16/854,398

(22) Filed: Apr. 21, 2020

(30) Foreign Application Priority Data
Apr. 26, 2019 (JP) 2019-086591

(51) Int. Cl. G06F 9/48; G06F 3/041

(52) U.S. Cl. CPC G06F 9/4893; G06F 2209/485; G06F 2209/482; G06F 3/0416

(57) ABSTRACT

An electronic device includes one or a plurality of control units configured to execute an application. The control unit includes a classification unit configured to classify the application as one of a plurality of categories according to a processing load and a parameter setting unit configured to set a control parameter for controlling the control unit according to the classified category.

### BACKGROUND

### 1. Field

The present disclosure relates to an electronic device, a control apparatus, an information processing apparatus, and an information processing system.

### 2. Description of the Related Art

There is a known technique in the relate art for storing a plurality of applications for each identification information and updating settings of, for example, illumination, vibration, and language, according to the identification information (Japanese Patent No. 5661936, Jan. 28, 2015).

In consideration of smooth execution of applications, it is desirable to operate the central processing unit (CPU) as fast as possible. However, the fast operation may cause a problem of increasing the power consumption.

An aspect of the disclosure has an object to provide a technique for enabling a control unit to operate with a control parameter suitable to an application while suppressing an excessive increase in power consumption.

### SUMMARY

In an aspect of the present disclosure, an electronic device includes one or a plurality of control units configured to execute an application. The control unit includes a classification unit configured to classify the application as one of a plurality of categories according to a processing load and a parameter setting unit configured to set a control parameter, such as the processing speed and the number of operating cores of the control unit, according to the classified category.

An aspect of the disclosure has an object to provide a technique for enabling a control unit to operate suitably to an application while suppressing an excessive increase in power consumption.

### BRIEF DESCRIPTION OF THE DRAWINGS

FIG. 1 is a block diagram of the main components of an electronic device according to a first embodiment of the present disclosure;

FIG. 2A is a table for use in control processing in the electronic device in FIG. 1;

FIG. 2B is a table illustrating association information for reference in assigning a category number;

FIG. 3 is a flowchart illustrating control processing performed by the electronic device in FIG. 1;

FIG. 4 is a block diagram of the main components of an information processing system according to a second embodiment of the present disclosure; and

FIG. 5 is a block diagram of the main components of an information processing system according to a third embodiment of the present disclosure.

### DESCRIPTION OF THE EMBODIMENTS

### First Embodiment

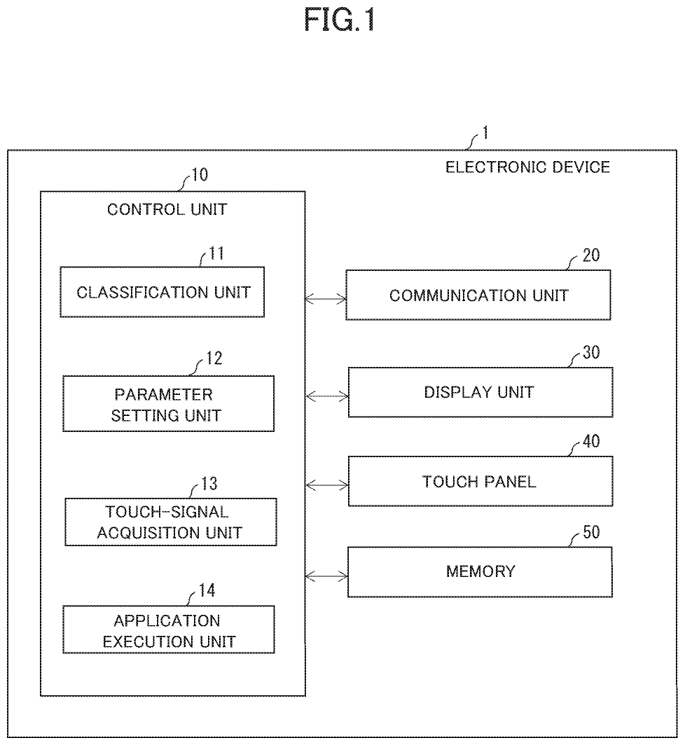

Referring to FIGS. 1 to 3, an electronic device 1 and a control unit (control apparatus) 10 will be described in detail hereinbelow.

### Main Components of Electronic Device

FIG. 1 is a block diagram of the main components of the electronic device 1 according to the present embodiment. As illustrated in FIG. 1, the electronic device 1 includes the control unit (control apparatus) 10, a communication unit 20, a display unit 30, a touch panel 40, and a memory 50 serving as a storage, for example. An example of the control unit 10 is a central processing unit (CPU) of the electronic device 1.

An example of the electronic device 1 is a smartphone. However, the electronic device 1 of the present disclosure is not limited to the smartphone and may be a tablet terminal with a communication function or a notebook computer.

The memory areas of the memory 50 of the electronic device 1 store various applications (hereinafter abbreviated to “apps”). The control unit 10 executes individual apps based on app information data stored in the memory areas in association with the individual apps.

Although FIG. 1 illustrates one control unit 10, the electronic device 1 may include a plurality of control units associated with a wide variety of apps. This allows processing loads on the electronic device 1 to be shared by the plurality of control units.

As illustrated in FIG. 1, the control unit (control apparatus) 10 of the present embodiment includes a classification unit 11, a parameter setting unit 12, a touch-signal acquisition unit 13, and an application execution unit 14.

### Classification Unit 11

The classification unit 11 classifies each of the plurality of apps as any of a plurality of categories according to their processing load.

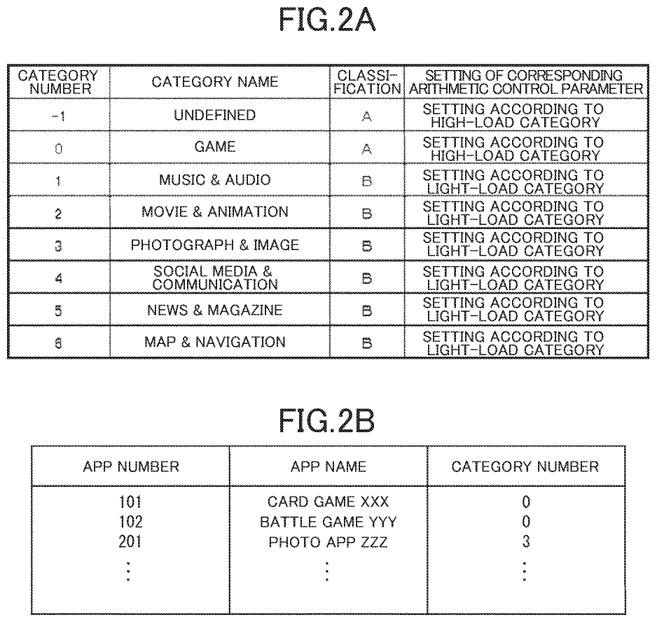

In an example, the classification unit 11 classifies the apps as any of the following categories, as illustrated in FIG. 2A:
Undefined
Game
Music & audio
Movie & animation
Photograph & image
Social media & communication
News & magazine
Map & navigation

As illustrated in FIG. 2A, the individual categories are given different category numbers. The classification unit 11 classifies the app to be classified as any of the plurality of categories by assigning a category number to the app.

In FIG. 2A, the categories corresponding to classification “A” are categories to which apps with higher processing loads than the processing loads of categories corresponding to classification “B” are assigned. In the example of FIG. 2A, since the categories assigned category numbers “−1” and “0” correspond to classification A, the categories have higher loads than classification B.

The classification unit 11 may perform classification processing with reference to association information in which app identification information for distinguishing the app from the other apps and category identification information for distinguishing the plurality of categories from one another are associated with each other.

In an example, the classification unit 11 may assign a category number to an app to which category information is not properly added at the start of the app and is classified as the category of “−1: Undefined” with reference the association information (an association table prepared in advance) illustrated in FIG. 2B. In the example of FIG. 2B, Card game XXX is associated with app number 101, which is app identification information, and category number 0, which is category identification information. The classification unit 11 can classify each app as a category associated therewith with reference to such association information.

### Parameter Setting Unit 12

The parameter setting unit 12 sets a control parameter according to the category assigned by the classification unit 11. The control parameter is used to control the processing speed and the number of cores of the control unit 10.

In an example, in executing applications classified as categories with a relatively high processing load (for example, apps classified as categories −1 and 0), the parameter setting unit 12 sets the control parameter so as to, for example, induce an increase in the operating frequency of the control unit 10 or to increase the number of cores as the processing load increases.

The “control parameter that induces an increase in the operating frequency of the control unit 10 or increases the number of cores as the processing load increases” is also referred to as “control parameter according to a high-load category”.

In executing applications classified as categories with a relatively low processing load, for example, categories 1 to 6, the parameter setting unit 12 sets the control parameter so as to, for example, suppress an increase in the operating frequency of the control unit 10 or to suppress an increase in the number of cores even if the processing load increases.

The “control parameter that suppresses an increase in the operating frequency of the control unit 10 or suppresses an increase in the number of cores even if the processing load increases” is also referred to as “control parameter according to a low-load category”.

The above configuration provides a technique for achieving a processing speed according to the application while suppressing an excessive increase in power consumption by setting (changing) the control parameter according to the processing load.

The configuration of the touch-signal acquisition unit 13 will be described later. The application execution unit 14 executes an app to be executed based on data on the app stored in a corresponding area of the memory 50.

The communication unit 20 communicates with an external device (not illustrated). The display unit 30 displays contents to be displayed by the electronic device 1. The touch panel 40 is operated by the user.

### Touch Panel

The electronic device 1 according to the present embodiment may further include a touch panel 40. The control unit 10 may further include the touch-signal acquisition unit 13 configured to obtain a touch signal according to the touch operation of the user on the touch panel 40. In this case, if the electronic device 1 is executing an application classified as a category with a relatively load processing load (for example, an app classified as one of categories 1 to 6) when the touch-signal acquisition unit 13 obtains the touch signal, the parameter setting unit 12 may set the control parameter for, for example, temporarily increasing the operating frequency of the control unit 10 or increasing the number of cores.

In general, when the touch panel 40 is operated by the user, a new process is generated in the control unit 10 due to the operation.

In the above configuration, when the touch-signal acquisition unit 13 obtains the touch signal, the parameter setting unit 12 sets the control parameter, for example, for temporarily increasing the operating frequency of the control unit 10 or increasing the number of cores. This provides a technique for achieving a processing speed according to the application while suppressing an excessive increase in power consumption.

If the electronic device 1 is executing an application classified as a category with a relatively high processing load (for example, an app classified as category −1 or 0) when the touch-signal acquisition unit 13 obtains the touch signal, the parameter setting unit 12 may set the control parameter for, for example, suppressing an increase in the operating frequency of the control unit 10 or suppressing an increase in the number of cores. The configuration may suppress the power consumption.

### Details of Control Processing

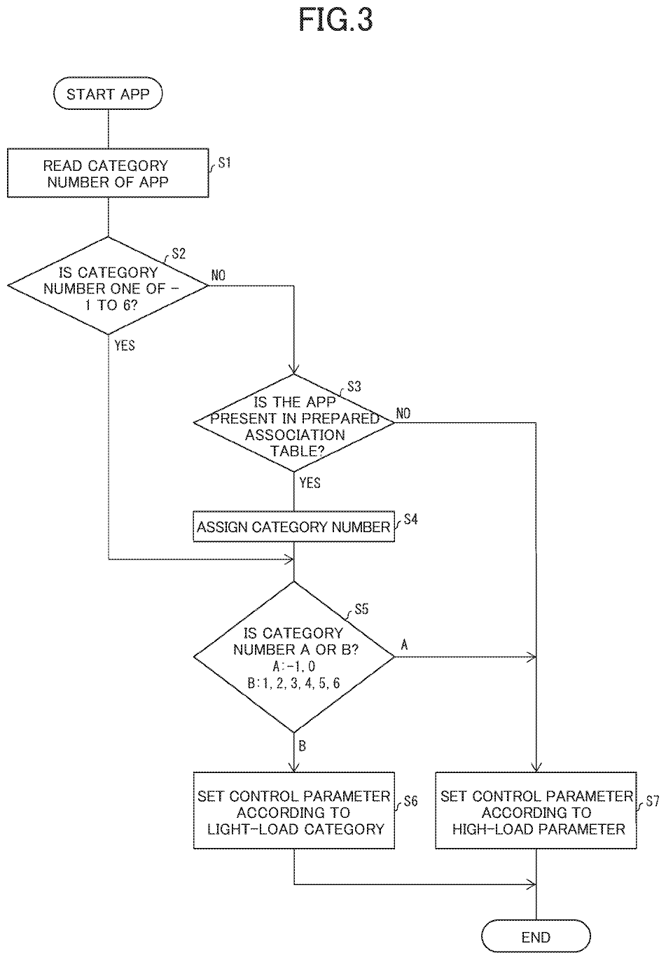

FIG. 3 is a flowchart illustrating the control processing performed by the electronic device 1 in FIG. 1. As illustrated in FIG. 3, when one app is started, the control unit 10 reads the category number of the app at step S1.

Subsequently, at step S2, the control unit 10 determines whether the category number is one of −1 to 6. If the determination result at step S2 is “YES”, the process goes to step S5.

If the determination result at step S2 is “NO”, the control unit 10 determines whether the app is present in an association table prepared in advance. If the determination result at step S3 is “YES”, then at step S4 the classification unit 11 assigns a category number to the app.

If the determination result at step S3 is “NO”, then at step S7 the control unit 10 regards the app as having a high processing load and sets a control parameter according to the high-load category.

At step S5, the classification unit 11 determines whether the category number is of classification A (the category number is −1 or 0) or classification B (the category number is one of 1 to 6).

If the determination result at step S5 is “A”, then at step S7 the control unit 10 regards the app as having a high processing load and sets a control parameter according to the high-load category. If the determination result at step S5 is “B”, then at step S6 the control unit 10 regards the app as having a light (low) processing load and sets a control parameter according to the light-load (low-load) category.

The above operation allows achieving the optimum control for each category by classifying each app as one of the plurality of categories and setting different control parameters to the individual categories.

This configuration ensures that, for example, an app with a light load but that is preferably updated at a higher frequency than 60 fps is reduced in power consumption by performing control so that the operating frequency or the number of cores of the control unit 10 is suppressed and, at a touch operation, the app is updated at a frequency higher than 60 fps by temporarily increasing the operating frequency of the control unit 10 or increasing the number of cores.

In contrast, for an app with a high load but that does not need necessarily be display at 60 fps, the control unit 10 is controlled so as to easily operate at a high operating frequency or in a state in which the number of cores is large and, in a touch operation, the operating frequency or the number of cores of the control unit 10 is not increased so that wasteful power consumption is suppressed.

Thus, for high-load category apps, the electronic device 1 according to the present embodiment can be comfortably used without generating slow response of display and, for light-load category apps, can be used for a long time by reducing the power consumption by setting a control parameter according to a high load and a light load, respectively.

### Second Embodiment

Another embodiment of the present disclosure will be described hereinbelow. Components having the same functions as the components described in the above embodiment are given the same reference signs, and descriptions thereof will be omitted.

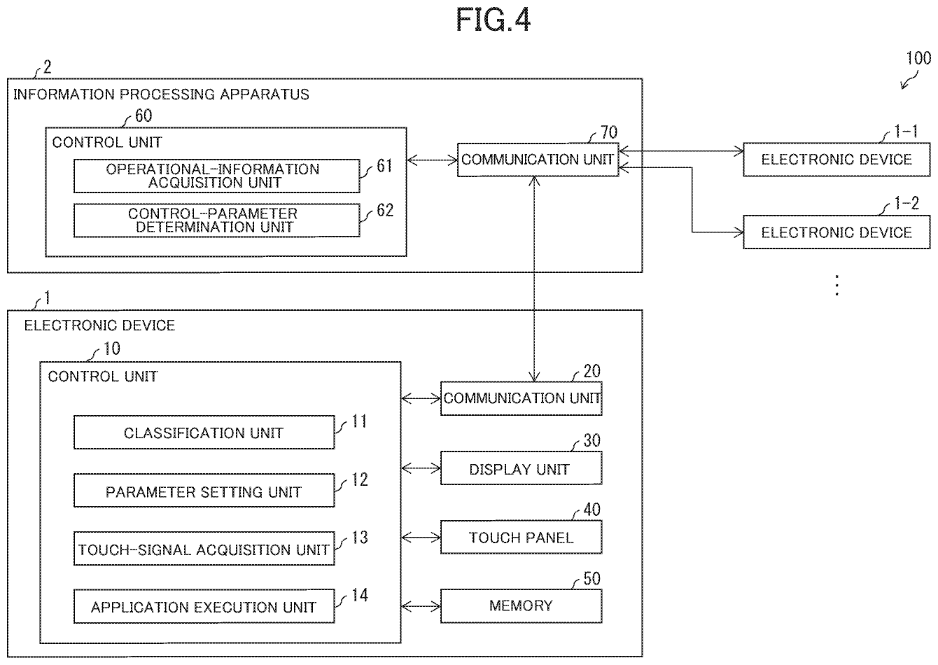

FIG. 4 is a block diagram of the main components of an information processing system 100 according to a second embodiment. The information processing system 100 includes an information processing apparatus 2, an electronic device 1, and other electronic devices 1-1, 1-2, . . . . The information processing system 100 may include any number of other electronic devices.

The electronic device 1 according to the present embodiment has substantially the same configuration as the configuration of the electronic device 1 described in the first embodiment. The other electronic devices 1-1, 1-2, . . . according to the present embodiment have substantially the same configuration as the configuration of the electronic device 1 according to the present embodiment.

### Information Processing Apparatus

As illustrated in FIG. 4, the information processing apparatus 2 includes a control unit 60 and a communication unit 70. The control unit 60 includes an operational-information acquisition unit 61 and a control-parameter determination unit 62.

### Operational-Information Acquisition Unit

The operational-information acquisition unit 61 of the information processing apparatus 2 obtains, via the communication unit 70, operational information including the operating frequencies of the control units 10 of a plurality of electronic devices (in FIG. 4, three electronic devices 1, 1-1, and 1-2) that execute an application.

The operational information obtained from each electronic device may further include the number of operating cores, the temperature, and fps (display update frequency) of the control unit that executes each application in each electronic device. Examples of the operational information are shown below. The device ID is identification information for distinguishing the plurality of electronic devices from one another. For example, device ID=1 refers to the electronic device 1, device ID=2 refers to the electronic device 1-1, and device ID=3 refers to the electronic device 1-2.

The number of operating cores of the control unit 10 is, in other words, information indicating how many processing circuits of the plurality of processing circuits of the control unit 10 are used.

### Examples of Operational Information

| | | | Number of | | |
|---|---|---|---|---|---|
| App | Device | Operating | operating | | |
| number | ID | frequency | cores | fps | Temperature |
| 101 | 1 | 1.2 Ghz | 2 | 60 | 40° C. |
| 101 | 2 | 1.2 Ghz | 2 | 60 | 42° C. |
| 101 | 3 | 1.2 Ghz | 2 | 60 | 39° C. |
| 102 | 1 | 1.8 Ghz | 3 | 120 | 55° C. |
| 102 | 2 | 1.8 Ghz | 3 | 120 | 57° C. |
| 102 | 3 | 1.8 Ghz | 3 | 120 | 53° C. |

### Control-Parameter Determination Unit

The control-parameter determination unit 62 determines a control parameter according to the application and for controlling the processing speed of the control unit 10 with reference to the operational information obtained by the operational-information acquisition unit 61. In one example, the control-parameter determination unit 62 determines a control parameter for each application and for each electronic device.

In one example, the control-parameter determination unit 62 specifies the degree of the processing load generated in one electronic device in executing one application with reference to operational information obtained by the operational-information acquisition unit 61. For example, the control-parameter determination unit 62 specifies whether the processing load is relatively high or low in one electronic device executing one application. The control-parameter determination unit 62 determines a control parameter suitable for the one electronic device in executing the one application according to the specified processing load.

The determined control parameter is transmitted to the corresponding electronic device (for example, the electronic device 1) via the communication unit 20. The electronic device (the electronic device 1) classifies the application as one of the plurality of categories according to the processing load using the classification unit 11 of the electronic device. The parameter setting unit 12 sets the control parameter determined by the information processing apparatus 2 as a control parameter for controlling the processing speed of the control unit 10 according to the classified category.

The control-parameter determination unit 62 may classify each app by category according to the determined control parameter or the specified processing load to generate association information (an association table prepared in advance), as illustrated in FIG. 2B.

### Third Embodiment

Still another embodiment of the present disclosure will be described hereinbelow. Components having the same functions as the components described in the above embodiment are given the same reference signs, and descriptions thereof will be omitted.

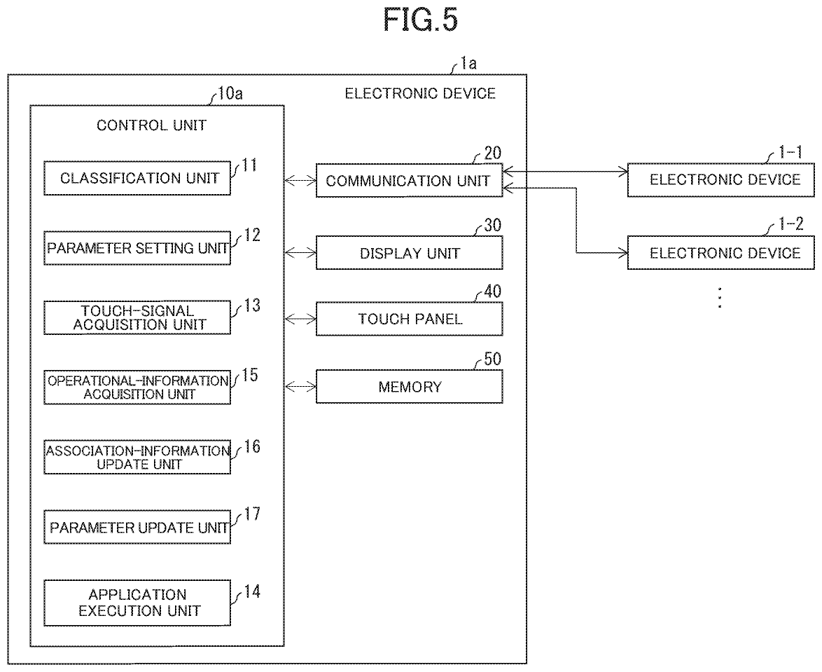

FIG. 5 is a block diagram illustrating the configuration of an electronic device 1a according to the present embodiment. As illustrated in FIG. 5, the electronic device 1a according to the present embodiment includes an operational-information acquisition unit 15, an association-information acquisition unit 16, and a parameter update unit 17, in addition to the components of the electronic device 1 according to the first embodiment.

The electronic device 1a according to the present embodiment may be configured to communicate with other electronic devices 1-1, 1-2, . . . .

### Operational-Information Acquisition Unit

The operational-information acquisition unit 15 obtains operational information including the operating frequency of the control unit 10a when executing the application in the past.

The operational information may further include at least one of:
Processing-circuit usage information (information indicating the number of cores used) indicating how many processing circuits of the plurality of processing circuits of the control unit 10a were used in executing the application in the past.
Temperature information on the control unit 10a in executing the application in the past.

### Association-Information Update Unit

The association-information update unit 16 updates the association information, described in the first embodiment, with reference to the operational information.

### Parameter Update Unit

The parameter update unit 17 updates the control parameter in executing the application with reference to the operational information.

Since the electronic device 1a according to the present embodiment updates at least one of the association information and the control parameter with reference to the operational information on the control unit 10a when executing the application in the past, a suitable control parameter can be determined.

### Implementation Examples Using Software

The respective control blocks (in particular, the control units 10 and 10a) of the electronic devices 1 and 1a may be implemented by a logic circuit (hardware) formed in an integrated circuit (an IC chip) or the like or by software.

In the latter case, the electronic devices 1 and la include a computer that executes instructions of a program, which is software for implementing various functions. The computer includes, for example, at least one processor (a control apparatus) and at least one computer-readable recording medium storing the program. In the computer, the processor reads the program from the recording medium and executes the program. An example of the processor is a central processing unit (CPU). Examples of the recording medium include “a non-transitory tangible medium”, such as a read-only memory (ROM), a tape, a disk, a card, a semiconductor memory, and a programmable logic circuit. The computer may further include a random access memory (RAM) in which the program is expanded. The program may be supplied to the computer via any transmission medium (a communication network or a broadcast wave) capable of transmitting the program. In one embodiment of the present disclosure, the program may be in the form of a data signal embodied by electronic transmission and embedded in a carrier wave.

The electronic device (1, 1a) according to a first aspect of the present disclosure includes one or a plurality of control units (10, 10a) configured to execute an application. The control unit (10, 10a) includes a classification unit (11) configured to classify the application as one of a plurality of categories according to its processing load and a parameter setting unit (12) configured to set a control parameter for controlling the control unit (10, 10a) according to the classified category.

The above configuration provides a technique for achieving an operation according to the application while suppressing an excessive increase in power consumption.

In a second aspect of the present disclosure, the electronic device (1, 1a) in the first aspect may be configured such that, in executing an application classified as a category of a relatively high processing load, the parameter setting unit (12) sets the control parameter so as to induce an increase in the operating frequency of the control unit (10, 10a) or increase the core count as the processing load increases, and in executing an application classified as a category of a relatively low processing load, the parameter setting unit (12) sets the control parameter so as to suppress an increase in the operating frequency of the control unit (10, 10a) and/or to suppress an increase in the core count even if the processing load increases.

The above configuration provides a technique for achieving a processing speed according to the application while suppressing an excessive increase in power consumption by setting (changing) the control parameter according to the processing load.

In a third aspect of the present disclosure, the electronic device (1, 1a) in the first aspect may further include a touch panel (40), and the control unit (10, 10a) may further include a touch-signal acquisition unit (13) configured to obtain a touch signal according to a touch operation on the touch panel (40), wherein when the touch-signal acquisition unit (13) obtains the touch signal, and if an application classified as a category of a relatively low processing load is in execution, the parameter setting unit (12) may set the control parameter so as to temporarily increase the operating frequency of the control unit (10, 10a) and/or increase the core count.

With the above configuration, when the touch-signal acquisition unit (13) obtains the touch signal, and if an application classified as a category of a relatively low processing load is in execution, the parameter setting unit (12) sets the control parameter so as to temporarily increase the operating frequency of the control unit (10, 10a) and/or increase the core count. This provides a technique for achieving a processing speed according to the application while suppressing an excessive increase in power consumption.

In a fourth aspect of the present disclosure, the electronic device (1, 1a) in the second aspect may further include a touch panel, and the control unit may further include a touch-signal acquisition unit (13) configured to obtain a touch signal according to a touch operation on the touch panel (40), wherein, when the touch-signal acquisition unit (13) obtains the touch signal, and if an application classified as a category of a relatively high processing load is in execution, the parameter setting unit (12) may set the control parameter so as to suppress an increase in the operating frequency of the control unit (10, 10a) and/or suppress an increase in the core count.

The above configuration can suppress power consumption.

In a fifth aspect of the present disclosure, the electronic device (1, 1a) in any one of the first to fourth aspects may be configured such that the classification unit (11) performs classification processing with reference to association information in which application identification information for distinguishing the application from another application and category identification information for distinguishing the plurality of categories from one another are associated with each other.

In a sixth aspect of the present disclosure, the electronic device (1, 1a) in the fifth aspect may be configured such that, the control unit (10a) further includes an operational-information acquisition unit (15) configured to obtain operational information including the operating frequency of the control unit (10a) in executing the application in the past, an association-information update unit (16) configured to update the association information with reference to the operational information, and a parameter update unit (17) configured to update the control parameter in executing the application with reference to the operational information, wherein the operational information further includes at least any one of processing-circuit usage information indicating how many processing circuits among a plurality of processing circuits of the control unit (10a) were used in executing the application in the past and temperature information on the control unit (10a) when the application was executed in the past.

With the above configuration, at least one of the association information and the control parameter is updated with reference to the operational information on the control unit (10a) when executing the application in the past. This allows determining a suitable control parameter.

In a seventh aspect of the present disclosure, a control apparatus (10, 10a) is a control apparatus (10, 10a) for executing an application. The control apparatus (10, 10a) includes a classification unit (11) configured to classify the application as one of a plurality of categories according to a processing load and a parameter setting unit (12) configured to set a control parameter for controlling the control unit (10, 10a) according to the classified category.

The above configuration provides the same advantageous effects as the advantageous effects in the first aspect.

In an eighth aspect of the present disclosure, an information processing apparatus (2) includes a communication unit (70) and a control unit (60). The control unit (60) obtains, via the communication unit (70), operational information including an operating frequency of a control unit (10) of each of a plurality of electronic devices in executing an application and determines a control parameter for controlling a processing speed and/or a core count of the control unit (10) that executes the application, the control parameter being according to the application, with reference to the obtained operational information. The operational information may further include at least any one of information indicating how many processing circuits among a plurality of processing circuits of the control unit (10) were used in executing the application in the past and temperature information on the control unit (10) when the application was executed in the past.

In a ninth aspect of the present disclosure, an information processing system (100) includes one or a plurality of electronic devices (1) and one or a plurality of information processing apparatuses (2). The information processing apparatus (2) includes a communication unit (70) and a control unit (60). The control unit (60) obtains, via the communication unit (70), operational information including an operating frequency of a control unit (10) of each of the plurality of electronic devices (1) in executing an application, determines a control parameter for controlling a processing speed and/or a core count of the control unit (10) that executes the application, the control parameter being according to the application, with reference to the obtained operational information, and supplies the determined parameter to each electronic device (1) via the communication unit (70). The control unit (10) of the electronic device (1) includes a classification unit (11) configured to classify the application as one of a plurality of categories according to a processing load and a parameter setting unit (12) configured to set the control parameter determined by the information processing apparatus (2) as a control parameter for controlling the processing speed and/or the core count of the control unit (10), according to the classified category.

The present disclosure contains subject matter related to that disclosed in Japanese Priority Patent Application JP 2019-086591 filed in the Japan Patent Office on Apr. 26, 2019, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic device comprising:
one or a plurality of control units configured to execute an application,
wherein the control unit includes:
a classification unit configured to classify the application as one of a plurality of categories according to a processing load; and
a parameter setting unit configured to set a control parameter for controlling the control unit according to the classified category.

2. The electronic device according to claim 1,
wherein, in executing an application classified as a category of a relatively high processing load, the parameter setting unit sets the control parameter so as to induce an increase in an operating frequency of the control unit and/or increase a core count as the processing load increases, and
wherein, in executing an application classified as a category of a relatively low processing load, the parameter setting unit sets the control parameter so as to suppress an increase in the operating frequency of the control unit and/or to suppress an increase in the core count even if the processing load increases.

3. The electronic device according to claim 2, further comprising a touch panel,
wherein the control unit further includes a touch-signal acquisition unit configured to obtain a touch signal according to a touch operation on the touch panel,
wherein, when the touch-signal acquisition unit obtains the touch signal, and if an application classified as a category of a relatively low processing load is in execution, the parameter setting unit sets the control parameter so as to temporarily increase the operating frequency of the control unit and/or increase the core count.

4. The electronic device according to claim 2, further comprising a touch panel,
wherein the control unit further includes a touch-signal acquisition unit configured to obtain a touch signal according to a touch operation on the touch panel,
wherein, when the touch-signal acquisition unit obtains the touch signal, and if an application classified as a category of a relatively high processing load is in execution, the parameter setting unit sets the control parameter so as to suppress an increase in the operating frequency of the control unit and/or suppress an increase in the core count.

5. The electronic device according to claim 1,
wherein the classification unit performs classification processing with reference to association information in which application identification information for distinguishing the application from another application and category identification information for distinguishing the plurality of categories from one another are associated with each other.

6. The electronic device according to claim 5,
wherein the control unit further includes:
an operational-information acquisition unit configured to obtain operational information including an operating frequency of the control unit in executing the application in the past;
an association-information update unit configured to update the association information with reference to the operational information; and
a parameter update unit configured to update the control parameter in executing the application with reference to the operational information,
wherein the operational information further includes at least any one of:
processing-circuit usage information indicating how many processing circuits among a plurality of processing circuits of the control unit were used in executing the application in the past; and
temperature information on the control unit when the application was executed in the past.

7. A control apparatus for executing an application, the apparatus comprising:
a classification unit configured to classify the application as one of a plurality of categories according to a processing load; and
a parameter setting unit configured to set a control parameter for controlling the control unit according to the classified category.

8. An information processing apparatus comprising:
a communication unit; and
a control unit,
wherein the control unit
obtains, via the communication unit, operational information including an operating frequency of a control unit of each of a plurality of electronic devices in executing an application, and
determines a control parameter for controlling a processing speed and/or a core count of the control unit that executes the application, the control parameter being according to the application, with reference to the obtained operational information,
wherein the operational information further includes at least any one of:
information indicating how many processing circuits among a plurality of processing circuits of the control unit were used in executing the application in the past; and
temperature information on the control unit when the application was executed in the past.

9. An information processing system comprising:
one or a plurality of electronic devices; and
one or a plurality of information processing apparatuses,
wherein the information processing apparatus includes a communication unit and a control unit,
wherein the control unit
obtains, via the communication unit, operational information including an operating frequency of a control unit of each of the plurality of electronic devices in executing an application, determines a control parameter for controlling a processing speed and/or a core count of the control unit that executes the application, the control parameter being according to the application, with reference to the obtained operational information, and
supplies the determined parameter to each electronic device via the communication unit, and
wherein the control unit of the electronic device includes:
a classification unit configured to classify the application as one of a plurality of categories according to a processing load; and
a parameter setting unit configured to set the control parameter determined by the information processing apparatus as a control parameter for controlling the control unit, according to the classified category.
